(19) United States
(12) Patent Application Publication
(10) Pub. No.: US 2006/0064745 A1
(43) Pub. Date: Mar. 23, 2006

(54) Device for including use-enabling means for enabling the device to be used in dependence on a gesture recognitiion

(76) Inventor: John Patrick Cass, London (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/534,163

(22) PCT Filed: Oct. 31, 2003
(86) PCT No.: PCT/IB03/04895

§ 371 Date: Nov. 8, 2005

(30) Foreign Application Priority Data
Nov. 12, 2002 (EP) 02102558.0
Nov. 2, 2003 (EP) 03100282.7

(51) Int. Cl. H04L 9/32

(52) U.S. Cl. 726/9

(57) ABSTRACT

In a device (1) are provided use enabling means (5) which are arranged for enabling the use of the device (1) if the security feature corresponds to fixedly predefined specified movement data while a security feature is taken into account, which security corresponds to at least one data circuit (DC1; DC2; DC3, DC4; DC5, DC6) and represents a movement of the at least one data circuit (DC1; DC2; DC3, DC4; DC5, DC6).

The invention relates to a device for processing user information, the device being arranged for cooperation with use enabling means, the latter means being arranged for enabling the use of the device taking account of a security feature that corresponds to a data circuit.

The invention further relates to a method of enabling a use of a device for processing user information, the use of the device being enabled by use enabling means taking account of a security feature, the security feature corresponding to a data circuit.

The invention further relates to a data carrier for enabling a use of a device with an electric circuit, the circuit comprising use enabling means and circuit components for producing communication means of the data carrier, which are provided for applying a security feature corresponding to a data circuit for which use enabling means are provided and where the use enabling means taking account of the security feature are arranged for generating a use enabling signal for enabling the use of the device.

The invention further relates to a circuit for a data carrier for enabling a use of a device, the circuit comprising use enabling means and circuit components for producing communication means of the data carrier, which are provided for applying a security feature that corresponds to a data circuit for which use enabling means are provided and where the use enabling means taking account of the security feature are arranged for generating a use enabling signal for enabling the use of the device.

Such a device of the type defined in the first paragraph and such a method of the type defined in the second paragraph and such a data carrier of the type defined in the third paragraph and such a circuit of the type defined in the fourth paragraph are known from patent document WO 97/45814.

The known device with which the known method can be performed is realized by a mobile terminal—in the present case actually by a mobile telephone—which terminal comprises the data carrier with the known circuit in the form of a so-called Subscriber Identification Module, SIM for short, where the SIM embodies use enabling means of the mobile telephone and the circuit contained therein embodies the data circuit. To be able to use the mobile telephone to carry out a business activity, a security code is to be entered by a user of the mobile telephone via a keypad of the mobile telephone, which security code corresponds to the SIM or data circuit respectively and with the aid of which the user is personally authorized. The security code entered in the mobile telephone is used for authorization of the user with the aid of the SIM and produces a security feature that can be rendered available to the mobile telephone. The use of the mobile telephone for the purpose of carrying out the business activity for an authorized user is made possible or released respectively as a result of the authorization by the SIM.

In the known communication device there is the problem that providing the security code only fulfils its purpose because the communication device is unlimitedly accessible for carrying out the business activity after the user has been authorized, so that also an unintentional business activity determined by a faulty operation by the authorized user or even deceitful activities by non-authorized users in case the authorized user is not careful and alert enough cannot be excluded. The security code provides a further problem in that such a security code is occasionally hard to remember for a user and is therefore not always available to the user. This is especially true when there are special circumstances for the user, such as, for example a situation of stress or a situation of increased attention, which circumstances practically claim the user's full concentration, so that entering a practically always extremely abstract security code becomes relatively difficult and relatively frequently leads to an erroneous entry if the user does not take into the bargain to reduce the circumstances-attendant attention to remember the security code and enter the security code. A further problem exists in a combination with a personalization of this security code, because personalization attempts usually lead to a use of a security code that can easily be guessed and therefore does not come up to its securing purpose.

It is an object of the invention to resolve the problem mentioned above with a communication device of the type defined in the first paragraph and with a method of the type defined in the second paragraph and with a data carrier of the type defined in the third paragraph and with a circuit of the type defined in the fourth paragraph and an improved communication device and an improved method and an improved data carrier and an improved circuit.

To achieve the object as defined above, a device in accordance with the invention has inventive features so that a device according to the invention can be characterized in the manner defined hereafter, that is a device for processing user information, the device being provided for cooperation with use enabling means, the latter means being arranged for taking account of a first security feature which first security feature corresponds to a data circuit and can be applied to the use enabling means and is formed by movement data, which movement data represent a movement of at least one data circuit along at least one defined track, and in which the use enabling means are arranged for enabling the use of the device when the movement data correspond to fixedly predefined specified movement data.

To achieve the object defined above, a method in accordance with the invention has inventive features so that a method according to the invention can be characterized in the manner defined hereafter, that is a method of enabling a use of a device for processing user information, in which for enabling a use of the device a first security feature is taken into account by use enabling means, which first security feature corresponds to at least one data circuit and is applied to the use enabling means and is formed by movement data which represent a movement of the at least one data circuit along at least one defined track and in which the use of the device is enabled if the movement data correspond to fixedly predefined specified movement data.

To achieve the object defined above a data carrier in accordance with the invention has the following features according to the invention, so that a data carrier according to the invention can be characterized in the manner defined hereafter, that is a data carrier for enabling a use of a device, comprising an electric circuit, the circuit comprising use enabling means and circuit components for producing first communication means of the data carrier which are arranged for contactless communication and which are provided for applying a first security feature to the use enabling means, which first security feature corresponds to at least one data circuit and is formed by movement data, the movement data representing a movement of the at least one data circuit along at least one track and in which the use enabling means are provided for taking the first security feature into account and for generating a use enabling signal if the movement data correspond to fixedly predefined specified movement data.

To achieve the object defined above a circuit according to the invention has the following features according to the invention, so that a circuit according to the invention can be characterized in the manner defined hereafter, that is a circuit for a data carrier to enable a use of a device, the circuit having use enabling means and the circuit comprising circuit components for producing first communication means of the data carrier which are provided for contactless communication and for applying a first security feature to the use enabling means, the first security feature corresponding to at least one data circuit and being formed by movement data, the movement data representing a movement of the at least one data circuit along a track and in which the use enabling means being provided for taking account of the security feature and for generating a use enabling signal if the movement data correspond to fixedly predefined specified movement data.

Providing the measures according to the invention includes the advantage that a security feature which can relatively easily be noticed by the user and especially complies with a user's individuality can be used without any problem, which allows a real personalization of this security feature as is practically always desired and with a nearly infinite variety and even without the securing effect of the security feature getting lost, which is quite opposite to a security feature based on abstract sign strings, with which security feature attempts mostly culminate in a use of a few very similar or even identical sign strings, so that the securing effect of such an abstract security feature often has to be questioned. A further advantage consists of the fact that a security feature based on a movement can relatively easily be noticed and can therefore even in situations of increased alertness and concentration be used relatively aptly without the alertness or concentration suffering therefrom, because generating a movement itself causing the security feature to arise can be carried out practically without any problem for a user in such a situation and without much concentration effort—namely, intuitively. Furthermore, the advantage is obtained that as a result of the use of different movements also the implementation of different functions in the device is made possible, which with a conventional abstract security code would normally fail in that too much would be asked from a user because of the multiplicity of security codes to be noticed and this feature would not be used.

With a solution according to the invention it has proved to be particularly advantageous if additionally the characteristics as claimed in claim 2 or 9 or 17 or 24 are provided. They bring in the advantage that in addition to the first security feature representing the movement, an additional second security feature for enabling the use of the device, such as for example an abstract security feature known from the state of the art and known per se and consisting of sign sequences or also a fingerprint or another biometric feature characteristic of a user can be used, that a personal individualization is hardly accessible or not accessible at all. This has proved to be particularly advantageous for the case where for example a hierarchical enabling of the use of the device should take place, so that for example with each level of use where there is the largest requirement as to security, a second security feature can be used in addition to the first security feature, without having to do without the individuality of the first security feature to reach this level of use. Consequently, deceitful or undesired use is then excluded with practically one hundred per cent certainty if a non-authorized user would gain the second security feature, because without the movement caused by an authorized user the second security feature is without any effect and therefore, in principle, there would then not be any serious security problem if a security feature comprising an abstract sign sequence is noted down on a piece of paper and would end up in the wrong hands. This further achieves the advantage that a use of the device at any time and at undesired places can be avoided with very much certainty as this is especially required when an activity is to be carried out for security reasons and for the purpose of avoiding undesired use by non-authorized persons, so that the protection against unauthorized use if only the conventional security code is used is improved considerably.

With a method according to the invention it has proved to be particularly advantageous if, additionally, the features as defined in claim 10 are provided. This provides the advantage that a highly cost-effective and economically advantageous execution of the method is possible with the device. This further achieves the advantage that an almost simultaneous taking account of the two security features can take place. Furthermore, the advantage is obtained that a unique assignment between a user and the two security features is given by the sole data circuit.

The solutions according to the invention have further proved to be advantageous if, additionally, the features as claimed in claim 3 or claim 11 are provided. The advantage is then obtained that the data circuit can be accommodated in an appliance outside the device, in which the second security feature can be applied to the data circuit for example by a keypad of the external appliance and is applied to the device by the data circuit during a contactless communication with the device, in which at the same time the movement of the data circuit accommodated in the external appliance can be taken into account as a consequence of maintaining the external appliance.

With the solutions according to the invention it has further proved to be advantageous if, additionally, the features as claimed in claim 4 or claim 12 are provided. Consequently, the advantage is obtained that a mobile embodiment of the device, such as, for example a mobile telephone, can be advantageously produced, the first security feature being in a position to be rendered available while use is made of a contactless communication for a suitable positioning sequence or during a suitable movement of the device as against a device provided for contactless communication with the first communication means of the data circuit.

In the solutions according to the invention there may be provided, for example, that the use enabling means are provided for detecting a movement in which optically generable information is used. However, it has proved to be particularly advantageous if additionally the features as claimed in claim 5 or claim 13 respectively are provided. This achieves the advantage that almost simultaneously with a communication between the device and the at least one data circuit the movement can be detected that renders an unauthorized or possibly deceitfully motivated use of the at least one data circuit or appliance practically impossible, because it can be established that the movement is indeed detected only by means of a certain data circuit or an exactly defined group of data circuits.

In the solutions according to the invention may be provided for example that the movement relative to the location is canceled one-dimensionally or two-dimensionally as a result of which at least a movement corresponding to a straight-line or curved track or a movement corresponding to a change of position of the at least one data circuit can be detected. However, it has proved to be particularly advantageous if, additionally, the characteristic features as claimed in claim 6 or claim 14 respectively are provided. This achieves the advantage that more particularly with a contactless communication between at least one data circuit and the device the available three coordinates of the space and a time-dependent change of the respective coordinates or the associated speed or acceleration can be taken into account for the detection of the movement, which is important with a complex movement consisting of a number of partial movements and/or changes of position, which movement may comprise movement phases as well as phases of rest.

In the solutions according to the invention may be provided for example, that the specified movement data are stored in the device. However, it has proved to be highly advantageous if, additionally, the features as claimed in claim 7 and 15 respectively are provided. This achieves the advantage that the specified movement data need not be stored locally in the device, but be saved or stored respectively, at a place away from the device, which enables a highly efficient use of the device for a multiplicity of users.

In a data carrier according to the invention and a circuit for a data carrier according to the invention it has further proved to be advantageous if, additionally, the features as claimed in claim 18 and 25 respectively are provided. This achieves the advantage that a movement occurring with a contactless communication is taken into account as a first security feature.

In the solutions according to the invention it has further proved to be advantageous if additionally the features as claimed in claim 19 and 26 respectively are provided. This offers the advantage that even with the occurrence of only a single antenna signal already a movement is available as a first security feature.

In the solutions according to the invention it has further proved to be advantageous if additionally the features as claimed in claim 20 and 27 respectively are provided. This offers the advantage that a movement detection depending on communication content is made possible.

In the solutions according to the invention it has further proved to be advantageous if additionally the features as claimed in claim 21 and 28 respectively are provided. This offers the advantage that a decision about the validity or the invalidity of security features can be made that cannot be influenced by an environment of the data carrier or circuit, which security features were applied to the data carrier or circuit respectively.

In the solutions according to the invention it has further proved to be advantageous if additionally the features as claimed in claim 22 and 29 respectively are provided. This offers the advantage that a use enabling signal can be produced that cannot be influenced by a contactless communication and therefore satisfies the strictest security standards.

The aspects defined hereinbefore and further aspects of the invention are apparent from the illustrative embodiments described hereinafter and are explained with reference to these illustrative embodiments.

The invention will be further described in the following with reference to four illustrative embodiments shown in the drawings, to which, however, the invention is not restricted, in which:

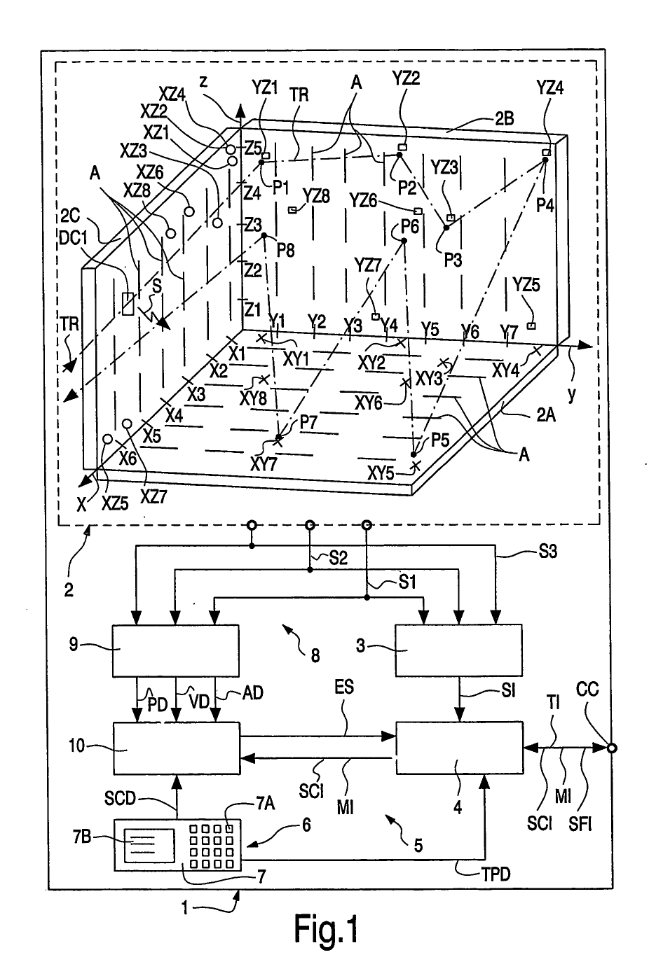

FIG. 1 shows in a diagrammatic way in the form of a block diagram a communication device in accordance with a first illustrative embodiment of the invention,

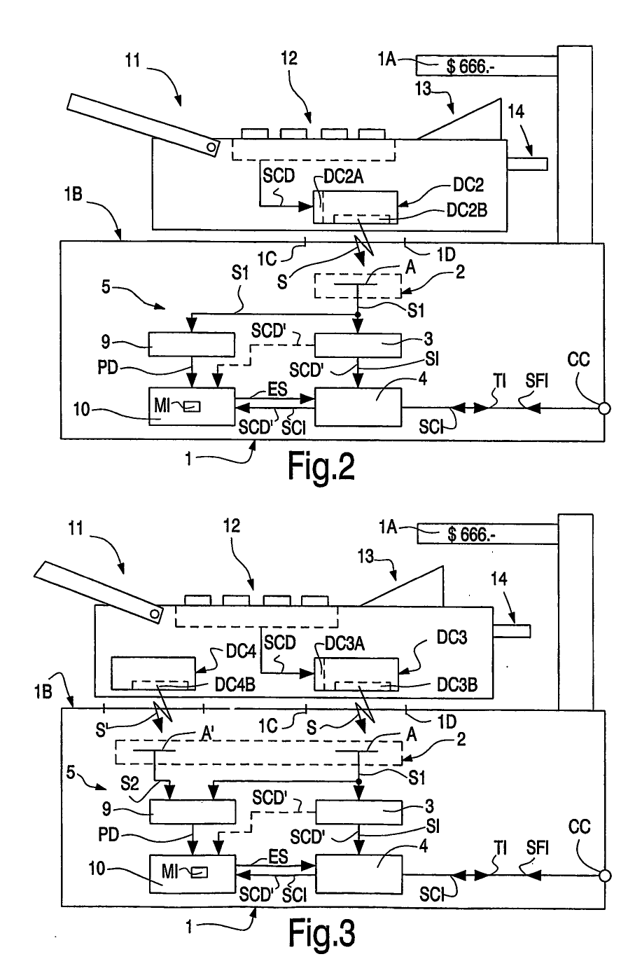

FIG. 2 shows in analogous way to FIG. 1 a communication device in accordance with a second illustrative embodiment of the invention,

FIG. 3 shows in analogous way to FIG. 1 a communication device in accordance with a third illustrative embodiment of the invention, and

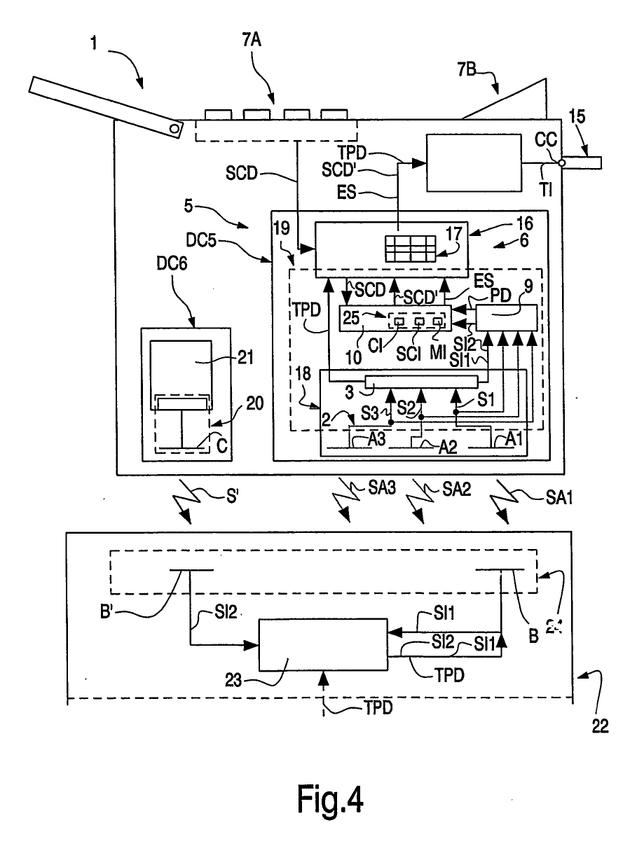

FIG. 4 shows in analogous way to FIG. 1 a communication device in accordance with a fourth illustrative embodiment of the invention.

FIG. 1 shows a device, a communication device 1, which is arranged for receiving a signal S which can be delivered by a first data carrier DC1 that can be inserted in a communication area of the communication device 1 and is arranged for contactless communication, which data carrier DC1 includes a data circuit not shown in the FIG. 1.

The communication device 1 has an antenna configuration 2 which is formed by a first antenna panel 2A, a second antenna panel 2B and a third antenna panel 2C. Each of the three antenna panels 2A, 2B, 2C has a number of antennas A schematically shown by lines in FIG. 1, only three respective antennas A per antenna panel 2A, 2B and 2C being given the reference character A. The antenna panels 2A, 2B and 2C meet in the origin of a Cartesian system, which is put up by the axes X, Y and Z. The first antenna panel is oriented parallel with the XY plane. The second antenna panel 2B is oriented parallel with the YZ plane. The third antenna panel 2C is oriented parallel with the XZ plane. The antennas A of the first antenna panel 2A have such a configuration that each antenna A has a reception lobe that stretches out in essence in the Z direction. The antennas A of the second antenna panel 2B have such a configuration that each antenna A has a reception lobe that stretches out in essence in the X direction. The antennas A of the third antenna panel 2C have such a configuration that each antenna A has a reception lobe that stretches out in essence in the Y direction. The antennas A further have such a configuration that neighboring reception lobes only slightly overlap. In the present case the first antenna panel 2A has twenty-four antennas A, the second antenna panel 2B twenty-one antennas A and the third antenna panel 2C eighteen antennas A. At this point it should be observed that also another number of antennas may occur per antenna panel 2A, 2B and 2C, the respectively selected number of antennas then corresponding to a required spatial solution concerning a position of the first data carrier DC1 within the communication area defined by the antenna configuration 2. It may further be provided that in lieu of the three antenna panels 2A, 2B and 2C only two antenna panels can be provided, for example the antenna panels 2A and 2B, in which in this case a movement of the first data carrier DC1 in the communication area can only be evaluated with respect to two coordinates of the coordinate system. In the present case there are Cartesian coordinates for characterizing a movement of the first data carrier DC1. In another case, where for example the individual antenna panels 2A, 2B and 2C are not arranged at right angles to each other, also polar coordinates may be provided for characterizing a movement.

The antenna configuration 2 can deliver first antenna signals S1, second antenna signals S2 and third antenna signals S3, the first antenna signals S1 representing the parts of the signal S receivable by the antennas A of the first antenna panel 2A and the second antenna signals S2 representing parts of the signal S receivable by the antennas A of the second antenna panel 2B and the third antenna signals S3 representing the parts of the signal S receivable by the antennas A of the third antenna panel 2C. Accordingly, the first antenna signals S1 are formed by twenty-four sub-signals, the second antenna signals S2 are formed by twenty-one sub-signals and the third antenna signals S3 are formed by eighteen sub-signals.

The communication device 1 includes a signal processing stage 3 which is arranged for receiving the first antenna signals S1 and the second antenna signals S2 and the third antenna signals S3 and for evaluating with the signal S signal information SI communicated to the communication device 1 and represented by the three groups of antenna signals S1, S2 and S3. The signal processing stage 3 is further arranged for delivering the evaluated signal information SI. The signal information SI serves to authorize a user of the communication device 1 or of the first data carrier DC1 as is described hereinafter.

The communication device 1 further comprises information processing means 4 which are provided for processing signal information SI. The information processing means 4 are further provided for querying security feature information SFI about a communication connection CC of the communication device 1 after processed signal information SI has been received, while a communication to a data processing device not shown in FIG. 1 and external to the communication device 1 can be effected. As a result of this communication the information processing means 4 are further arranged for receiving the security feature information SFI from the data processing device, in which the security feature information SFI has security code information SCI which forms specified security information and has specified movement data MI. The security code information SCI represents a security code that can be rendered available by a user of the communication device 1. The specified movement data MI represent the movement of the first data carrier DCI that can be caused by a user of the communication device 1. The information processing means 4 are further arranged for delivering the security code information SCI and the specified movement data MI. The information processing means 4 are further arranged for receiving a use enabling signal ES and, as a consequence of the reception of the use enabling signal ES for enabling a use of the communication device 1 for carrying out a business transaction. For this purpose the information processing means 4 are further arranged for receiving transaction parameter data TPD and, while utilizing the signal information SI and the transaction parameter data TPD, for generating and delivering transaction information TI via the communication connection CC, which transaction information TI forms user information.

For generating the use enabling signal ES for the information processing means 4 the communication device 1 includes use enabling means 5. The use enabling means 5 are arranged for enabling the use of the communication device 1, thus for generating and delivering the use enabling signal ES to the information processing means 4, if the security code entered by the user corresponds to the security code information SCI and if, additionally, the movement of the first data carrier DC1 caused by the handling of the first data carrier DC1 corresponds to the specified movement data MI, if a second security feature corresponding to the first data carrier DC1 and which can be rendered available to the communication device 1, that is to say, the security code that can be entered by a user of the communication device 1 and if a first security feature corresponding to the first data carrier DC1 or to its data circuit, which first security feature represents the movement of the first data carrier DC1 caused by a user of the communication device 1 when the first data carrier DC1 is handled.

Accordingly, the use enabling means 5 are arranged such that the two security features can be taken into account if the two security features correspond to the first data carrier DC1 or its data circuit, which matter will be discussed hereafter.

For the user to enter the security code by hand, the communication device 1 comprises a second security feature feeding stage 6, which is realized by an input/output interface 7, the latter having a keypad 7A for entering alphanumeric signs and a display 7B for visualizing input alphanumeric signs or for visualizing indications or messages for the user of the communication device 1. The second security feature feeding stage 6 is further arranged for delivering the security code data SCD representing the security code input by the user. Via the keypad 7A may further be fed adjustable or selectable transaction parameters in connection with the business transaction, which parameters can be delivered in the form of transaction parameter data TPD to the information processing means 4.

The communication device 1 further includes a first security feature supply stage 8 by means of which the communication device 1 can be supplied with the first security feature, that is, the movement of the first data carrier DC1 or its data circuit or this feature can be rendered available to the device 1. The first security feature supply stage 8 comprises for this purpose a movement detection stage, which is realized by the antenna configuration 2. The first security feature supply stage 8 further comprises a movement detection stage 9 which is provided for receiving the first antenna signals S1, the second antenna signals S2 and the third antenna signals S3 and, based on the antenna signals S1, S2 and S3, for detecting the respective current movement in which the three coordinates X, Y and Z of the space are taken into account as well as a time-dependent change of the three coordinates X, Y and Z. The movement detection stage 9 is further arranged for generating and delivering position data PD, velocity data VD and acceleration data AD, the position data PD representing the position at a respective instant of the first data carrier DC1 relative to the coordinate origin within the communication area and the velocity data VD representing the velocity at the respective position of the first data carrier DC1 and the acceleration data AD representing the acceleration at the respective position of the first data carrier DC1. The data PD, VD and AD form movement data which movement data form the first security feature. Accordingly, the use enabling means 5 assisted by the antenna configuration 2 forming the movement detection stage are arranged for receiving the signal S from the first data carrier DC1 in a contactless manner which data carrier DC1 can be inserted in the communication area of the communication device land assisted by the movement detection stage 9 for detecting the movement of the data carrier DC1 or its data circuit while use is made of the signal S that can be received from the first data carrier DC1.

The communication device 1 further includes a security feature processing stage 10 which is arranged for receiving the security code data SCD and for receiving the position data PD, the velocity data VD and the acceleration data AD. The security feature processing stage 10 is further arranged for receiving the specified security information SCI and the specified movement data MI. The security feature processing stage 10 is further arranged for generating and delivering the use enabling signal ES to the information processing means 4 if the entered security code corresponds to a comparison code represented by the security code information SCI, that is to say, corresponds to the specified security information and if, additionally, the movement between the data carrier DC and the communication device 1 corresponds to specified status of the movement represented by the specified movement data MI.

In the following the mode of operation of the communication device 1 is explained with reference to an illustrative embodiment for the communication device 1 as shown in FIG. 1. According to this illustrative embodiment it is assumed that the communication device 1 is a part of an electronic registration cash desk which is connected to a communication server of a department store via its communication connection CC, the communication server on its side being connected for communicating with data processing arrangements of banks or credit card companies or data carrier management agencies via the Internet and/or the telephone network, so that electronic business transactions can be carried out with the aid of the communication device 1. The business transactions in the present case are cashless payments for goods.

In the first data carrier DC1 is stored information that enables a querying of security code information SCI that corresponds to a user and specified movement data MI from a data carrier management agency corresponding to the same user, in order to be able to establish in the communication device 1 whether the user is at all authorized to utilize the communication device 1.

For this purpose the communication device 1 is provided for implementing a method of enabling the use of the communication device 1. It is then assumed that the first data carrier DC1 with its data circuit is moved—in the present case by a user—along the movement track TR which is shown in a dashed line along the points P1, P2, P3, P4, P5, P6, P7 and P8. The movement track TR chosen by the user and only known to the user moves along straight connection lines between the points P1 to P8. Once the first data carrier DC1 has been inserted in the communication area of the communication device 1, the signal S can be received with the three antenna panels 2A, 2B and 2C and can be delivered to the signal processing stage 3 and the movement detection stage 9 in the form of the first antenna signal S1, the second antenna signal S2 and the third antenna signal S3.

According to the method the communication device 1 receives the specified movement data M1 corresponding to the second security feature, which data represent the specified status of the movement of the data carrier DC. For this purpose in the data processing stage 3 first the information is evaluated that is communicated to the communication device 1 by means of the signal S for querying the security code information SCI and the specified movement data MI. During this operation the information stored in the first data carrier DC1 is delivered to the information processing means 4 in the form of signal information SI. The information processing means 4 subsequently query the user-specific security code information SCI assigned to the first data carrier DC1 and the specified movement data MI from the data carrier management agency. The security code information SCI sent by the data carrier management agency to the communication device 1 as well as the specified movement data MI are delivered to the security feature processing stage 10 by the information processing stage 4.

According to the method the use of the communication device 1 with the first security feature and the second security feature is made possible if the second security feature corresponds to the security code information SCI and if the first security feature corresponds to the specified movement data which represent the specified status of the movement, the two security features corresponding to the first data carrier DC1 or its data circuit and the second security feature representing the security code entered by the user and the first security feature representing the user-caused movement of the first data carrier DC1 or of the data circuit included therein.

According to the method the signal S of the first data carrier DC1 inserted in the communication area is further received in a contactless way and the communication device 1 detects the movement making use of the signal S caused by the first data carrier DC1 and received by the communication device 1.

Then almost simultaneously with the processing of the antenna signals S1, S2 and S3 in the signal processing stage 3 comes the detection of the movement status in the movement detection stage 9 in which use is made of the first antenna signals S1, the second antenna signals S2 and the third antenna signals S3. The movement track TR chosen for the first data carrier DC1 by the user then has in essence a three-dimensional pattern zigzagging in the communication area. Then there is a change of direction at the points P1 to PS. The space-dependent position of the individual points P1 to P8 is indicated in the FIG. 1 by their projections on the first antenna panel 2A, the second antenna panel 2B and the third antenna panel 2C, the projections on the first antenna panel 2A being indicated by crosses XY1 to XY8 and the projections on the second antenna panel 2B by squares YZ1 to YZ8 and the projections on the third antenna panel 2C by crosses XZ1 to XZ8. Accordingly the projections of the point P1 are featured by the reference characters XY1, YZ1 and XZ1. Furthermore, the projections of the point P2 are featured by the reference characters XY2, YZ2 and XZ2. Further, the projections of the point P3 are featured by the reference characters XY3, YZ3 and XZ3. Further, the projections of the point P4 are featured by the reference characters XY4, YZ4 and XZ4. Further, the projections of the point P5 are featured by the reference characters XY5, YZ5 and XZ5. Further, the projections of the point P6 are featured by the reference characters XY6, YZ6 and XZ6. Further, the projections of the point P7 are featured by the reference characters XY7, YZ7 and XZ7. Further, the projections of the point P8 are featured by the reference characters XY8, YZ8 and XZ8.

According to the method the movement of the data carrier DC1 is detected taking into account the three coordinates X, Y and Z of the space and a time-dependent change of the coordinates X, Y and Z. For this purpose, as soon as the signal S is received by the antennas A of the antenna configuration 2, the position data PD are continuously generated and delivered in the movement detection stage 9 and the velocity data VD and acceleration data AD are generated and delivered to the security feature evaluation stage 10 based on a time-dependent change of the first antenna signal S1, the second antenna signal S2 and the third antenna signal S3. The data PD, VD and AD thus generated are continuously stored by the security feature processing stage 10 after a movement track TR has been finished, thus after the first data carrier DC1 was again removed from the communication area, and compared with the specified status of the movement represented by the specified movement data MI.

Then in the security feature processing stage 10 the security code entered by the user by means of the keypad 7A is compared with the comparison code represented by the security code information SCI. Not until the two security features applied to the communication device, that is to say, the security code entered by the user and the movement caused by the user, corresponds to the security code information SCI or the specified movement data MI, is the use enabling signal ES generated by the security feature processing stage 10 and delivered to the information processing means 4. Not until this time can the communication device 1 be used by a user to execute a business transaction, for which transaction-parameter data TPD entered or selected by the input/output interface 7 are delivered by the communication device 1 via the transaction information TI.

This offers the advantage that for enabling the use of the communication device 1 not only a security code that is usually hard to notice and therefore often written on a piece of paper in a user's purse, but in addition to the customary security code a movement of the first data carrier DC1 is taken into account that is easy notice for a user and can be performed very individually in many ways and is only known to this one user, which movement considerably improves the protection against unauthorized use compared to the conventional security code.

At this point it should be observed that the movement track TR may also include curved track elements which can be generated for example by a signature-like movement of the first data carrier DC1 within the communication area.

It should further be observed that also a plurality of data carriers may be present whose common or successive movement can be taken into account as a first security feature in the communication device 1. This is particularly of interest if the data carriers occur at various positions mutually apart in a personal item such as a ballpoint or a keyring of a user of the communication device.

The data carrier DC1 is in the present case realized by a so-called chipcard, as they are used in a cashless society.

It should be observed, however, that the data carrier DC1 may also be produced as an intelligent label or as a part of a piece of garment or of a piece of jewelry or as part of another product the everyday life.

The communication device 1 shown in FIG. 2 produces an electronic cash terminal for which a cash terminal display 1A is provided by which an amount to be paid can be displayed to the customer.

FIG. 2 further shows a mobile telephone 11 which comprises a telephone keypad 12 and a telephone display 13 and a second data carrier DC2, which includes a data circuit. In the communication device 1 is further included a cash terminal deposit surface 1B on which is visible optically perceivable to a user a position range for positioning the mobile telephone 11 which stretches out between two position marks 1C and 1D. It should be observed that the position range may also stretch out in the form of a circle or a square.

The data carrier DC2 installed in the mobile telephone 11 is in the present case equipped with a first interface DC2A which is arranged for contactless communication, and a second interface DC2B which is arranged for contactless communication in inductive manner. The security code data SCD on the data carrier DC2 can be received by means of the first interface DC2A, which code data in the present case can be entered by the user of the mobile telephone 11 by means of the telephone keypad 12. The data carrier DC2 further has encoding means not shown in FIG. 2 which are provided as a protection against deceitful wheeling and dealing for generating encoded security code data SCD′ corresponding to the security code data SCD.

The communication device 1 is arranged for contactless communication with the data carrier DC2 and for this purpose has the antenna configuration 2 which is here formed by a single loop-shaped antenna A by means of which an electromagnetic field defining the communication range of the antenna configuration 2 can be generated in a region between the position marks 1C and 1D.

Once the mobile telephone 11 is positioned on the cash terminal deposit surface 1B so that the data carrier DC2 ends up between the position marks 1C and 1D in the vicinity of the antenna A, there can be communication with the data carrier DC2 when use is made of the second interface DC2B of the data carrier DC2. According to the method communication takes place here between the communication device 1 and the data carrier DC2 or its data circuit and both the first security feature and the second security feature for enabling the use of the communication device 1 are offered or rendered available to this communication device 1, which will be discussed in more detail hereafter.

During communication not only the signal S, but also a component of the signal information SI as well as the encoded security code data SCD′ can be communicated to the communication device 1, in which the antenna signal S1 can be supplied by the antenna A. The signal processing stage 3 in the present case is used not only for delivering the signal information SI but also for evaluating and delivering the encoded security code data SCD′ to the information processing means 4. The information processing means 4 are in the present case provided additionally for delivering the encoded security code data SCD′ to the security feature processing stage 10.

The movement detection stage 9 is arranged for receiving the antenna signal S1 and for generating the position data PD which in the present case show the movement of the data carrier DC2 in the way that the data carrier DC2 is inserted in the communication area by a movement once the antenna signal S1 can be received. As a result, the specified status of the movement is given by the fact that contactless communication with the data carrier DC can be realized. Accordingly, the communication device 1 is arranged for offering or rendering both the first security feature and the second security available to the use enabling means 5 use is made of the contactless communication between the communication device 1 and the data carrier DC. In this case the first security feature supply stage 6 is formed by the antenna configuration 2, the signal processing stage 3 and the information processing means 4. At this point it should be observed that the first security feature supply stage 6 may also be formed by the antenna configuration 2 and the signal processing stage 3 while in this case the signal processing stage 3 is provided for supplying the encoded security code data SCD′ to the security feature processing stage 10 as this is shown in FIG. 2 by the broken line between the signal processing stage 3 and the security feature processing stage 10.

It should further be observed that the cash terminal deposit surface 1B can also be arranged inside a mobile phone cradle of the cash terminal 1, as a result of which positioning of the mobile phone 11 is made easier for the user. Furthermore there may be provided that for the purpose of positioning the mobile phone 11 at least a strip-like element can be installed on the cash terminal deposit surface 1B.

It should further be observed that the movement detection stage 9 may also be provided for monitoring as to whether the mobile phone 11 starting from a first touching of the keypad 12 until a final touching of the telephone keypad 12 is positioned inside the communication area. It should further be observed that the movement detection stage 9 may also include time measuring means by which for example a defined time of presence in the communication area can be monitored.

A further observation is that the movement detection stage 9 may also be arranged for detecting a sequence of movements, characterized by presence and absence of the second data carrier DC2 in the communication area, while different time criterions may be important for parts of the sequence. As a result, for example an application can be realized in which the mobile phone is to be removed very rapidly three times in from the communication area and brought back into the communication area after the security code has been successfully entered by the telephone keypad 12 as an entry of second security feature.

It should further be observed that the antenna configuration 2 can also have more than one antenna and that the specified status of the movement may be defined by a sequential accessing of the second data carrier DC2 for a contactless communication with the individual antennas and that the movement detection stage 9 may be arranged for processing sequentially occurring antenna signals.

The communication device 1 shown in FIG. 3 has two antennas A and A′ positioned a distance apart in the neighborhood of their cash terminal deposit surface 1B, the first antenna signal S1 being receivable from the first antenna A and the second antenna signal S2 being receivable from the second antenna A′. The mobile telephone 11 shown in FIG. 3 has a fourth data carrier DC4 in addition to a third data carrier DC3 which has a configuration similar to the second data carrier DC2 shown in FIG. 2, which fourth data carrier DC4 similarly to the third data carrier DC3 is designed for contactless communication and for this purpose has a third interface DC4B and in its turn comprises a data circuit. In the present case the third data carrier DC3 can be supplied with electric energy for its operation via the first interface DC3A. The fourth data carrier DC4 can be supplied with electric energy via an inductive coupling between the antenna configuration 2 and an induction loop (not shown in FIG. 3) of the third interface DC4B with the aid of the third interface DC4B. In this case the specified condition of the movement of the two data carriers DC3 and DC4 is given in that the mobile telephone 11 is positioned on the cash terminal deposit surface 1B so that the position of the third data carrier DC3 corresponds to the antenna A and the position of the fourth data carrier DC4 corresponds to the antenna A′. In this position a simultaneous communication with the two data carriers DC3 and DC4 or with their data circuits is made possible, where the signal S can be received by the first antenna A and the first antenna signal S1 representing the signal S can be delivered by the first antenna A, and where a signal S′ that may be caused by the third data carrier DC3 can be received by the second antenna A′ and the second antenna signal S2 representing the signal S′ can be delivered to the movement detection stage 9 by the second antenna A′ which is arranged for detecting and evaluating the appearance of the two antenna signals S1 and S2.

Also in the present case it should be observed that the specified condition of the movement of the two data carriers DC3 and DC4 may be defined as a static condition as well as a change of condition alternating between presence and absence within the communication areas of the antennas A and A′, which alternating change of condition can be generated by the user by suitably handling the mobile telephone 11.

The communication device 1 shown in FIG. 4 embodies a mobile telephone. The communication device 1 comprises a telephone antenna 15 connected to its communication connection CC by means of which the transaction information TI can be communicated. The communication device 1 further comprises a fifth data carrier DC5 which in its turn comprises a data circuit and is produced as a dual interface data carrier, which fifth data carrier DC5 comprises second communication means 16 which are arranged for contact-bound communication and which are provided for rendering the second security feature available and which comprise a multiplicity of contacting fields 17 by means of which the fifth data carrier DC5 can be brought into contact with corresponding contacting fields not shown in FIG. 4 of the communication device 1. The security code data SCD can be supplied to the fifth data carrier DC5 via the second communication means 16 from the keypad 7A. Accordingly, the second communication means 16 produce the second security feature supply stage 6 of the communication device 1 and the second security feature corresponds to the fifth data carrier DC5 or to its data circuit, respectively.

The fifth data carrier DC5 further comprises first communication means 18 which are provided for contactless communication and for rendering the first security feature available, so that they form the first security feature supply stage 8, which will be further discussed hereafter.

The fifth data carrier DC5 further comprises a first electric circuit 19 forming its data circuit, which comprises circuit components for realizing the second communication means 16 and the first communication means 18, which are provided for generating and for delivering or receiving and for processing, respectively, electric signals occurring during the respective communication. The communication device 1 further comprises the antenna configuration 2 to which circuit 19 is connected and which has a third antenna A1 in this case. The third antenna A1 forms part of the first communication means 18.

In the present case the use enabling means 5 are realized by the fifth data carrier DC5 or by its data circuit, so that according to the method the use of the communication device 1 is enabled by the fifth data carrier DC5 or its data circuit, respectively.

The communication device 1 further includes a sixth data carrier DC6 which has a fourth interface 20 which is arranged for contactless communication and has a second electric circuit 21 which forms its data circuit. The fourth interface 20 has a fourth antenna C which is connected to the circuit 21 and by means of which a contactless communication can be effected. The sixth data carrier DC6 is installed in the communication device 1 at a distance from the fifth data carrier DC5. The first security feature corresponds in the present case to the two data carriers DC5 and DC6 and to their data circuits respectively, and represents a movement of the two data carriers DC5 and DC6.

The two antennas A1 and C are in the present case arranged inside the respective data carrier DC5 or DC6, the data carriers DC5 and DC6 here being arranged as a chipcard and rendering a space available necessary for the respective antenna A1 or C, so that the position of the two antennas A1 and C within the communication device 1 in essence corresponds to the position of the respective data carrier DC5 or DC6 within the communication device 1. The data carrier DC5 can be inserted in the communication device 1 and removed therefrom. However, it should be observed that the antennas A1 and C respectively may be accommodated irrespective of the respective position of the data carriers DC5 and DC6, in which in a case like this the two data carriers DC5 and DC6 are to include connection means which make a connection possible between the respective data carriers DC5 and DC6 and the associated respective antenna A1 or C. This is especially advantageous when the data carriers DC5 and DC6 are inseparably integrated in the communication device, or are present in the form of relatively small modules and the antenna A1 and C are arranged in parts of a housing of the communication device 1. This is particularly necessary if coils are provided as the antennas A1 or C, which coils are to cover a certain minimum surface to enable contactless communication. At this point it should be observed that the antennas of the antenna configuration 2 can also be produced by means of single-pole or multipole antennas. It should further be observed at this point that in lieu of the data carriers DC5 and DC6 also only their data circuits may be provided, which are then to be equipped with respective communication means. The data circuits may be provided for example as part of electronics of the mobile phone but may also be provided independent of these electronics.

FIG. 4 further shows part of an electronic cash terminal 22 which includes a terminal signal processing stage 23 and a terminal antenna configuration 24. The terminal antenna configuration 24 comprises a fifth antenna B and a sixth antenna B′, each of the antennas B and B′ being provided for cooperation with a respective antenna that can be installed opposite. The terminal signal processing stage 23 is connected to the antennas B and B′ and, utilizing the antennas B and B′, provided for generating and delivering a respective high-frequency excitation signal which, within a relatively small communication area of the respective antenna B or B′, has its effects in their neighborhood. By means of the excitation signal the two data carriers DC5 and DC6 can be supplied with electric energy as soon as they are inserted in the communication area assigned to the respective antenna B or B′ by a suitable handling of the communication device 1.

In the present case the specified condition of the movement of the two data carriers DC5 and DC6 or their data circuits is defined such that the fifth data carrier DC5 or the third antenna A1 respectively is positioned opposite to the fifth antenna B and the sixth data carrier DC6 or the fourth antenna C opposite to the sixth antenna B′. In this specified condition, by means of a modulation of the respective excitation signal, a signal S representing first signal information SI1 can be communicated from the fifth data carrier DC5 and furthermore a signal S′ representing second signal information SI2 from the sixth data carrier DC6 to the terminal antenna configuration 24 and afterwards also to the terminal signal processing stage 23.

The terminal signal processing stage 23 is arranged for processing the two signal information signals SI1 and SI2. The terminal signal processing stage 23 is further arranged for contactless communication of its available transaction data TPD to the fifth data carrier DC5 by means of a modulation of the excitation signal as soon as the first signal information SI1 can be received. In similar manner also the signal information SI1 or SI2 present at the terminal signal processing stage 23 can be communicated to the fifth data carrier DC5.

The use enabling means 5 are in the present case arranged for taking account of the movement of the mobile phone relative to the cash terminal 22 while the antenna signal S1 is used, which will be further discussed hereafter.

The modulated excitation signal can be received by the antenna A1 from the fifth data carrier DC5. The signal processing stage 3 is arranged for receiving the antenna signal S1 that can be delivered by the antenna A1 and for evaluating the antenna signal S1 with respect to the two signal information items SI1 and SI2. By means of the signal processing stage 3 the antenna signal S1 can be converted into the respective signal information items SI1 and SI2 and as the case may be into the transaction data TPD. In the present case the movement detection stage 9 is connected downstream of the signal processing stage 3 and arranged for detecting the movement while use is made of the signal information SI1 and SI2 represented by the antenna signal S1. For this purpose the movement detection stage 9 can detect whether the first signal information SI1 and the second signal information SI2 occur synchronously. Accordingly, the positioning data PD that can be delivered by the movement detection stage 9 represent the time-dependent appearance of both signal information SI1 and SI2. Furthermore, there is provided that the second signal information SI2 can be rendered available in the security feature processing stage 10 for a further check.

The security feature processing stage 10 is arranged for receiving the security code data SCD representing the first security feature and for receiving the positioning data PD representing the second security feature and, if the security code data SCD correspond to the security code information SCI and the positioning data PD correspond to the specified movement data MI arranged for generating and delivering the use enabling signal ES.

The security feature processing stage 10 is in the present case arranged for checking whether the second signal information SI2 was really generated by the sixth data carrier DC6. The check information CI necessary for checking the signal information SI2 is stored in the fifth data carrier DC5 by memory means 25. Furthermore, the memory means 25 can store the security code information SCI and the specified movement data MI, which security code information and specified movement data represent in this case the simultaneous occurrence of the two signal information SI1 and SI2 as a specified condition of the movement of the two data carriers DC5 and DC6. This implies that the fifth data carrier DC5 is positioned opposite to the fifth antenna B and the sixth data carrier DC6 opposite to the sixth antenna B′ if the two signal information signals SI1 and SI2 occur simultaneously and the second signal information items SI2 really comes from the sixth data carrier DC6.

It should be observed that the two information signals SCI and MI can also be applied to the communication device 1 via the communication connection CC as this was explained with reference to FIG. 1.

The use enabling signal ES that can be generated by the security feature processing means 10 can be delivered to the second communication means 16 by means of which the use enabling signal ES can be communicated to the information processing means 4 in a contact-bound way, after which the information processing means 4 can process the transaction parameter data TPD as a constituent part of the transaction information TI, which transaction parameter data TPD can be received via the first communication means 16, and the communication device 1 can deliver the transaction information TI.

It should be observed that also in the case at hand the specified condition of the movement of the two data carriers DC5 and DC6 may be given by a time-dependent sequence of presence or absence of one of the data carriers DC5 or DC6 or of the two data carriers DC5 and DC6 with respect to the positions of the two antennas B and B′.

It should further be observed that the movement detection stage 9 may also be arranged for receiving the antenna signal S1 and for evaluating a signal strength of the antenna signals S1, as a result of which conclusions about the state of movement may be drawn during the time-dependent variation of the signal strength. In this connection it should further be observed that also in the case at hand the movement detection stage 9 may also be arranged for generating velocity data VD and/or acceleration data AD in addition to the position data PD.

Referring to FIG. 4 it should further be observed that the two data carriers DC5 and DC6, in which the signals S and S′ are used and the terminal antenna configuration 24 and the terminal signal processing stage 23 may be arranged for communicating with each other, while the movement detection stage 9 may be arranged for detecting the movement of the two data carriers DC5 and DC6 employing or evaluating such a communication. In this connection it should further be observed that the security feature information SFI may be stored, for example, in the sixth data carrier DC6 and during such communication can be rendered accessible or rendered available to the fifth data carrier DC5.

It should further be observed that the second communication means 18 may also comprise a multiplicity of antennas A1, A2 and A3 and that the signal processing means 3 may be arranged for processing antenna signals S1, S2 and S3 which are assigned to a respective one of the antennas A1, A2 and A3, as this is shown in FIG. 4 by dotted lines. Such an antenna configuration 2 may for example be interesting if the specified state of the movement of the fifth data carrier DC5 is defined by information content of information rendered available by the respective antenna A1, A2 or A3 or by the presence or absence of some or all antenna signals S1, S2 or S3 of the individual antennas A1, A2 or A3, respectively. In a case like this it has proved to be particularly advantageous if the fifth data carrier DC5 has the movement detection stage 9 in addition to the signal processing stage 3, to which detection stage 9 the respective antenna signals S1, S2 and S3 can directly be and which is arranged for a direct evaluation of the antenna signals S1, S2 and S3, which is indicated in FIG. 4 by dotted lines.

At this point it should be observed that the communication device 1 may also comprise only the fifth data carrier DC5 and that the sixth data carrier DC6 may be omitted. This is particularly advantageous if the antenna configuration 2 has a plurality of antennas arranged mutual distances apart, such as for example the antennas A1, A2 and A3 or the communication device 1 which includes in addition to the communication means 18 the antennas assigned to the, second communication means 18.

It should further be observed that a data carrier provided for contactless communication may also be arranged for contactless communication in a capacitive way.

Even if in the examples of embodiments discussed hereinbefore, all in connection with the enabling of the use of the communication device 1, were specified to transaction information TI to be delivered by the communication device 1, it should be observed at this point that in connection with the enabling of the use of the communication device 1 the user information may also be in the form of receive information which can be received by the communication device 1 and which is to be accessible particularly to a user who makes himself known as an authorized user of the communication device 1 by means of the first security feature and the second security feature. In this connection it should further be observed that the device may also be formed by a laptop or by a so-called personal digital assistant for the use of which the processing of user information by the use enabling means 5 can be made possible.

Furthermore, it should be observed at this point that the device may also comprise a combination of a mobile phone—thus a communication device—and a so-called personal digital assistant, and that by different movements of one or more data circuits, which may be inside or outside such a combination device, different functions of the combination device may be enabled for use by a user.

It should further be observed that the second security feature can also be represented by biometric features such as, for example, a fingerprint.

As regards the excitation signal modulation which is the case with contactless communication it should be established that this is an amplitude modulation of the excitation signal. It should particularly be pointed out that the modulation which can be effected by means of the fifth data carrier DC5 can be generated by a load modulation of the excitation signal. It should be observed, however, that there may also be a reflexion modulation. It should further be observed that the modulation of the excitation signal may also be a phase or frequency modulation.

Further, it should be observed that also the first security code itself can be provided for enabling the device.

It should further be observed that the data circuit as such in the form of a relatively small integrated circuit can also be used independent of a data carrier or its housing such as, for example, as an implant in the body of a human being or as a component of an electric circuit of an appliance to which the data circuit is inseparably connected. In this connection it should further be observed that the data circuit in the form of an integrated or discrete circuit may also form the use enabling means of the device.

It should further be observed that a data circuit or a data carrier comprising the data circuit in a device can be used long before the method is implemented or immediately when the method is implemented.

1. A device for processing user information, the device being arranged for cooperation with use enabling means, the use enabling means being arranged for taking a first security feature into account which first security feature corresponds to a data circuit and can be applied to the use enabling means and is formed by movement data, the movement data representing a movement of the at least one data circuit along at least one defined track, and the use enabling means being arranged for enabling the use of the device if the movement data correspond to fixedly predefined specified movement data.

2. A device as claimed in claim 1, the use enabling means being arranged for taking a second security feature into account in addition to the first security feature, the second security feature corresponding to a data circuit and being feedable to the use enabling means and the use enabling means being arranged for enabling the use of the device if in addition to the movement data corresponding to the fixedly predefined specified movement data the second security feature corresponds to specified security code information.

3. A device as claimed in claim 2, the device being arranged for contactless communication with at least one data circuit, the data circuit on its part being arranged for contactless communication and the device, using contactless communication between the device and the data circuit, being arranged for feeding both the first security feature and the second security feature to the use enabling means.

4. A device as claimed in claim 2, the device comprising a data circuit by means of which the use enabling means are realized, the data circuit comprising first communication means arranged for contactless communication and for feeding the first security feature to the data circuit and the data circuit comprising second communication means arranged for contact-bound communication and for feeding the second security feature to the data circuit.

5. A device as claimed in claim 1, the device being arranged for contactless communication with at least one data circuit, the data circuit in its turn being arranged for contactless communication and the device being arranged for receiving a signal produced by at least one data circuit and the use enabling means, using the received signal, being arranged for detecting the movement of the at least one data circuit.

6. A device as claimed in claim 1, the use enabling means being arranged for detecting the movement of the at least one data circuit while three coordinates of the space and a time-dependent change of the three coordinates are taken into account.

7. A device as claimed in claim 2, the device being arranged for receiving the specified movement data assigned to the second security feature representing the specified state of the movement while the data circuit is taken into account, to which data circuit the second security feature corresponds.

8. A method of enabling a use of a device for processing user information, the use of the device being enabled by use enabling means taking account of a first security feature, the first security feature corresponding to at least one data circuit and being applied to the use enabling means and being formed by movement data, the movement data representing a movement of the at least one data circuit along at least one defined track and the use of the device being enabled if the movement data correspond to fixedly predefined specified movement data.

9. A method as claimed in claim 8, in which for enabling the use of the device a second security feature is taken into account by the use enabling means in addition to the first security feature, the second security feature corresponding to a data circuit and being fed to the use enabling means, and the use of the device being enabled by the use enabling means if in addition to the movement data, corresponding to the fixedly predefined specified movement data, the second security feature corresponds to specified security information.

10. A method as claimed in claim 9, in which a first security feature and a second security feature are used which both correspond to a single data circuit.

11. A method as claimed in claim 9, in which contactless communication takes place between the device which is arranged for contactless communication and at least one data circuit, which data circuit in its turn is arranged for contactless communication, and in which during contactless communication both the first security feature and the second security feature are fed to the use enabling means to enable the use of the device.

12. A method as claimed in claim 9, in which a data circuit is used for enabling the use of the device, which data circuit is inserted in the device for executing the method and by means of which data circuit the use enabling means are realized and which data circuit comprises first communication means which are arranged for contactless communication and for feeding the first security feature to the data circuit, and which data circuit comprises second communication means which are arranged for contact-bound communication and for feeding the second security feature to the data circuit.

13. A method as claimed in claim 8, in which at least one data circuit arranged for contactiess communication and inserted in a communication area of the device produces a signal and this signal is received by the device in a contactless manner and in which the movement of the at least one data circuit is detected by utilizing the received signal.

14. A method as claimed in claim 8, in which the movement of the at least one data circuit is detected by taking three coordinates of the space into account as well as a time-dependent change of the three coordinates.

15. A method as claimed in claim 8, in which the device receives the specified movement data, which are assigned to the second security feature and represent the specified status of the movement.

16. A data carrier for enabling the use of a device, comprising an electric circuit, the electric circuit comprising use enabling means and the circuit comprising components for realizing first communication means of the data carrier which are arranged for the contactless communication and provided for applying a first security feature to the use enabling means, which first security feature corresponds to at least one data circuit and is formed by movement data, the movement data representing a movement of the at least one data circuit along at least one track and the use enabling means being arranged for taking the first security feature into account and for generating a use enabling signal if the movement data correspond to fixedly predefined specified movement data.

17. A data carrier as claimed in claim 16, in which the circuit comprises components for realizing second communication means of the data carrier which are arranged for contact-bound communication and which are arranged for applying a second security feature to the use enabling means, which second security feature corresponds to the data carrier and in which the use enabling means in addition to the first security feature are arranged for taking the second security feature into account and in which the use enabling means are arranged for enabling the use of the device if in addition to the movement data which correspond to the fixedly predefined specified movement data, the second security feature corresponds to specified security information.

18. A data carrier as claimed in claim 16, in which the circuit can be connected to an antenna configuration by which antenna configuration at least one antenna signal can be delivered to the circuit during contactless communication and in which the use enabling means while using the at least one antenna signal is arranged for taking account of the movement of the at least one data circuit as a first security feature.

19. A data carrier as claimed in claim 18, in which the use enabling means comprise a signal processing stage which is arranged for receiving the at least one antenna signal and for evaluating the at least one antenna signal with respect to at least one signal information item representing the first security feature.

20. A data carrier as claimed in claim 18, in which the use enabling means comprise a movement detection stage which is arranged for detecting the movement of the at least one data circuit while using at least one signal information item contained in the at least one antenna signal and representing the first security feature.

21. A data carrier as claimed in claim 17, in which the use enabling means (5) comprise a security feature processing stage (10) which is arranged for receiving movement data (PD, VD, AD) forming the first security feature and for receiving data (SCD) representing the second security feature and which, if the movement data correspond to the specified movement data and the data representing the second security feature correspond to the specified security information are arranged for generating and delivering the use enabling signal.

22. A data carrier as claimed in claim 17, in which the use enabling means are arranged for delivering the use enabling signal to the second communication means.

23. A circuit for a data carrier for enabling a use of a device, which circuit comprises use enabling means and which circuit comprises components for realizing first communication means of the data carrier which are arranged for the contactless communication and are provided for applying a first security feature to the use enabling means, which first security feature corresponds to at least one data circuit and is formed by movement data, the movement data representing a movement of the at least one data circuit along at least one track and the use enabling means being arranged for taking the first security feature into account and for generating a use enabling signal if the movement data (PD, VD, AD) correspond to fixedly predefined specified movement data.

24. A circuit as claimed in claim 23, in which the circuit comprises components for realizing first communication means of the data carrier which are arranged for contact-bound communication and are provided for applying a second security feature to the use enabling means which second security feature corresponds to the data carrier and in which the use enabling means in addition to the first security feature are arranged for taking account of the second security feature and in which the use enabling means are arranged for enabling the use of the device if, in addition to the movement data which correspond to the fixedly predefined specified movement data, the second security feature corresponds to a specified security information item.

25. A circuit as claimed in claim 23, in which the circuit can be connected to an antenna configuration from which antenna configuration during contactless communication at least one antenna signal can be delivered to the circuit and in which the use enabling means, while using the at least one antenna signal, is arranged for taking account of the movement of the at least one data circuit.

26. A circuit as claimed in claim 25, in which the use enabling means comprise a signal processing stage, which is arranged for receiving the at least one antenna signal and for evaluating the at least one antenna signal with respect to at least one signal information item representing the first security feature.

27. A circuit as claimed in claim 25, in which the use enabling means comprise a movement detection stage which is arranged for detecting the movement of the at least one data circuit while use is made of at least one signal information item contained in the at least one antenna signal and representing the first security feature.

28. A circuit as claimed in claim 24, in which the use enabling means comprise a security feature processing stage which is arranged for receiving movement data forming the first security feature and for receiving data representing the second security feature and which, if the movement data correspond to the specified movement data and the data representing the second security feature correspond to the specified security code information, is arranged for generating and for delivering the use enabling signal.

29. A circuit as claimed in claim 24, in which the use enabling means are arranged for delivering the use enabling signal to the second communication means.
